(19) United States
(12) Patent Application Publication
(10) Pub. No.: US 2009/0042017 A1
(43) Pub. Date: Feb. 12, 2009

(54) Surface Protective Sheet

(75) Inventors: Keiichi Kitahara, Saitama (JP); Masato Saito, (US); Masuo Koyama, (US); Yoshihisa Kimura, (US)

Correspondence Address: COOPER & DUNHAM, LLP, 30 Rockefeller Plaza, 20th Floor, NEW YORK, NY, 10112, US

(73) Assignee: KIMOTO CO., LTD., Tokyo (JP)

(21) Appl. No.: 10/594,255

(22) PCT Filed: Mar. 25, 2005
(86) PCT No.: PCT/JP05/05483

§ 371 Date: Aug. 18, 2008

(30) Foreign Application Priority Data
Mar. 30, 2004 (JP) 2004-098059
May 26, 2004 (JP) 2004-156041

(51) Int. Cl. B32B 5/16

(52) U.S. Cl. 428/323

(57) ABSTRACT

To provide a surface protective sheet having superior anti-ultraviolet property and exhibiting little yellow tint.

The surface protective sheet of the present invention has an anti-ultraviolet layer on at least one surface of a plastic film, and the anti-ultraviolet layer comprises an ultraviolet absorber, an ionizing radiation curable resin composition, and spherical microparticles having a mean particle diameter of 1 to 20 μm, and the microparticles are contained in an amount of 0.4 to 3% by weight in the anti-ultraviolet layer. The anti-ultraviolet layer preferably contains 0.01 to 1% by weight of organopolysiloxane.

### TECHNICAL FIELD

The present invention relates to a surface protective sheet suitable for protecting surfaces of displays such as direction boards, advertisements, signboards, signs, posters, doorplates and name plates.

### BACKGROUND ART

In order to protect surfaces of displays such as direction boards, advertisements, signboards and signs, surface protective sheets are conventionally used. For such surface protective sheets, a property that surfaces thereof hardly suffer from scratches (henceforth referred to as “hard coat property”), and a property that they prevent change and fading of colors of images and the like as display contents caused by the influence of ultraviolet rays etc. (henceforth referred to as “anti-ultraviolet property”) are desired.

As a surface protective sheet satisfying these requirements, a surface protective sheet having an anti-ultraviolet layer comprising an ultraviolet curing type resin and an ultraviolet absorber on a surface of a plastic film has been proposed (refer to Patent document 1).

Since the surface of such a surface protective sheet has the hard coat property and the anti-ultraviolet property in certain degrees, they are sufficient for preventing scratches on the surface or color fading of images. However, when images or backgrounds are in a white color or pale color, they cause a problem that tint of the color changes due to the ultraviolet absorber. In particular, when such a surface protective sheet is used as those for displays for which lights of a predetermined wavelength region must be precisely absorbed in order to prevent activation of contained components by lights like electronic paper, it must have a relatively large content of ultraviolet absorber, and thus it makes yellow tint intense, and tint of the color is markedly changed.

[Patent document 1] Japanese Patent Unexamined Publication (KOKAI) No. 2003-11281 (claim 1)

### DISCLOSURE OF THE INVENTION

### Problem to be Solved by the Invention

Therefore, an object of the present invention is to provide a surface protective sheet exhibiting superior anti-ultraviolet property and little yellow tint.

### Means for Solving the Problem

The surface protective sheet of the present invention is a surface protective sheet having an anti-ultraviolet layer on at least one surface of a plastic film, wherein the anti-ultraviolet layer comprises at least an ionizing radiation curable resin composition, an ultraviolet absorber and spherical microparticles having a mean particle diameter of 1 to 20 μm, and the microparticles are contained in an amount of 0.4 to 3% by weight in the anti-ultraviolet layer.

The anti-ultraviolet layer preferably contains 0.01 to 1% by weight of an organopolysiloxane.

The anti-ultraviolet layer preferably has a thickness of 20 to 80% of the mean particle diameter of the microparticles.

The mean particle diameter referred to in the present invention is represented with a value measured and calculated by the Coulter counter method.

Further, the thickness of the anti-ultraviolet layer means a thickness of a portion consisting of the resin and having no convex portion formed by the microparticles.

### Effect of the Invention

Since the surface protective sheet of the present invention has superior anti-ultraviolet property and shows little yellow tint, it can prevent color fading of pictures, characters and images on the surfaces of displays etc., and in particular, it can protect images or backgrounds without changing tint even when they are in a white or pale color.

### BEST MODE FOR CARRYING OUT THE INVENTION

The surface protective sheet of the present invention has an anti-ultraviolet layer comprising an ionizing radiation curable resin composition, an ultraviolet absorber and spherical microparticles of a particular shape in a specific amount on at least one surface of a plastic sheet. Hereafter, embodiments of each of the constituents will be explained.

Although the plastic film is not particularly limited, a plastic film showing high transparency and having a small b* value in the L*a*b* color coordinate system (henceforth simply referred to as “b* value”) is preferred, and specifically one having a b* value of 3.0 or less, more preferably 1.5 or less, is preferred. Examples of such a plastic film include, for example, those of polyethylene terephthalate, polybutylene terephthalate, polyethylene naphthalate, polycarbonate, polyethylene, polypropylene, polystyrene, triacetylcellulose, acrylic resin, polyvinyl chloride, norbornene compound, and so forth. A biaxially stretched polyethylene terephthalate film is particularly preferably used, because it shows superior mechanical strength and dimensional stability. It is preferable to use a plastic film subjected to a treatment for easy adhesion such as plasma treatment, corona discharge treatment, far ultraviolet ray irradiation treatment and formation of under layer for easy adhesion for at least the surface on which the anti-ultraviolet layer is to be formed. Further, in order to further improve the anti-ultraviolet property or to obtain durability thereof, a plastic film in which an ultraviolet absorber is incorporated may also be used.

The L*a*b* color coordinate system means a color specification system represented according to the method for specifying colors defined by International Commission on Illumination (CIE) in 1976, and the b* value referred to in the present invention means the value measured and calculated according to JIS K5600-4-4:1999, JIS K5600-4-5:1999, and JIS K5600-4-6:1999.

Although the thickness of the plastic film is not particularly limited, it may be about 10 to 500 μm, preferably 50 to 300 μm, if handling property, mechanical strength, and so forth are taken into consideration.

Hereafter, the ionizing radiation curable resin composition constituting the anti-ultraviolet layer will be explained. The ionizing radiation curable resin composition is used as a binder component for retaining the ultraviolet absorber and the microparticles. By using the ionizing radiation curable resin composition, mars on the surface of the anti-ultraviolet layer can be prevented. As the ionizing radiation curable resin composition, photopolymerizable prepolymers that can be crosslinked and cured by irradiation of ionizing radiation (ultraviolet ray or electron beam) can be used. As the photopolymerizable prepolymers, acrylic type prepolymers having two or more acryloyl groups in one molecule and forming a three-dimensionally reticular structure through crosslinking and curing can be particularly preferably used. As such acrylic type prepolymers, urethane acrylate, polyester acrylate, epoxy acrylate, melamine acrylate, polyfluoroalkyl acrylate, silicone acrylate and so forth can be used. Although these acrylic type prepolymers can be used alone, photopolymerizable monomers are preferably added in order to give various performances such as improvement in crosslinking and curing properties, and control of shrinkage upon curing.

As the photopolymerizable monomers, one or more kinds of monomers among monofunctional acrylic monomers such as 2-ethylhexyl acrylate, 2-hydroxyethyl acrylate, 2-hydroxypropyl acrylate, and butoxyethyl acrylate, bifunctional acrylic monomers such as 1,6-hexanediol diacrylate, neopentylglycol diacrylate, diethylene glycol diacrylate, polyethylene glycol diacrylate and hydroxypivalic acid ester neopentylglycol diacrylate, polyfunctional acrylic monomers such as dipentaerythritol hexaacrylate, trimethylpropane triacrylate, and pentaerythritol triacrylate, and so forth are used.

When the anti-ultraviolet layer is cured by ultraviolet irradiation, additives such as photopolymerization initiators and photopolymerization promoters are preferably added, besides the photopolymerizable prepolymers and the photopolymerizable monomers mentioned above.

Examples of the photopolymerization initiator include acetophenone, benzophenone, Michler's ketone, benzoin, benzyl methyl ketal, benzoyl benzoate, α-acyloxime ester, thioxanthone, and so forth, and it is preferable to use a photopolymerization initiator having a peak of absorption wave range separated by 20 nm or more from the absorption wave range of the ultraviolet absorber mentioned later. If this condition is satisfied, sufficient curing of the anti-ultraviolet layer can be obtained, and thus superior hard coat property can be imparted.

The photopolymerization promoter can increase the curing rate and reduce disturbance of polymerization by air upon curing. Examples thereof include p-dimethylaminobenzoic acid isoamyl ester, p-dimethylaminobenzoic acid ethyl ester, and so forth.

Moreover, so long as the functions of the surface protective sheet of the present invention are not degraded, other resins such as thermoplastic resins and thermosetting resins may be added as a binder component, besides the aforementioned ionizing radiation curable resin composition.

Hereafter, the ultraviolet absorber constituting the anti-ultraviolet layer will be explained. The ultraviolet absorber is used in order to prevent color change or fading of images and so forth as display contents of displays due to influence of ultraviolet rays etc. Examples of the ultraviolet absorber include conventionally known ultraviolet absorbers such as salicylic acid type compounds, cyanoacrylate type compounds, benzophenone type compounds, benzotriazole type compounds, and so forth. Among these, the benzophenone type compounds and/or benzotriazole type compounds are preferred in view of compatibility with the ionizing radiation curable resin mentioned above, weather resistance for use in the outdoors, and so forth. In the present invention, a low molecular weight type ultraviolet absorber, specifically, a ultraviolet absorber having a formula weight of about 200 to 400, is still more preferably used compared with an ultraviolet absorbing resin, which is a high molecular weight type ultraviolet absorber, from the viewpoint of reducing yellow tint of the anti-ultraviolet layer. Since the low molecular weight type ultraviolet absorber can generally impart superior anti-ultraviolet property with a relatively smaller amount compared with the high molecular weight type ultraviolet absorber, it can not only reduce yellow tint, but also prevent reduction of the hard coat property without inhibiting the curing at the time of the formation of the anti-ultraviolet layer.

Examples of the benzophenone type compounds include 2-hydroxy-4-methoxybenzophenone, 2,4-dihydroxybenzophenone, 2-hydroxy-4-n-octoxybenzophenone, 2-hydroxy-4-methoxy-2′-carboxybenzophenone, 2,2′-dihydroxy-4,4′-dimethoxybenzophenone, 2-hydroxy-4-benzoyloxybenzophenone, 2,2′-dihydroxy-4-methoxybenzophenone, 2-hydroxy-4-methoxy-5-sulfonylbenzophenone, 2,2′,4,4′-tetrahydroxybenzophenone, 2,2′-dihydroxy-4,4′-dimethoxybenzophenone, 2-hydroxy-5-chlorobenzophenone, bis(2-methoxy-4-hydroxy-5-benzoylphenyl)methane, and so forth.

Examples of the benzotriazole type compounds include 2-(2′-hydroxyphenyl)benzotriazole, 2-(2′-hydroxy-5′-methylphenyl)benzotriazole, 2-(2′-hydroxy-5′-methylphenyl)-5-carboxybenzotriazole butyl ester, 2-(2′-hydroxy-5′-methylphenyl)-5,6-dichlorobenzotriazole, 2-(2′-hydroxy-5′-methylphenyl)-5-ethylsulfonylbenzotriazole, 2-(2′-hydroxy-5′-t-butylphenyl)-5-chlorobenzotriazole, 2-(2′-hydroxy-5′-t-butylphenyl)benzotriazole, 2-(2′-hydroxy-5′-aminophenyl)benzotriazole, 2-(2′-hydroxy-3′,5′-dimethylphenyl)benzotriazole, 2-(2′-hydroxy-3′,5′-dimethylphenyl)-5-methoxybenzotriazole, 2-(2′-methyl-4′-hydroxyphenyl)benzotriazole, 2-(2′-stearyloxy-3′,5′-dimethylphenyl)-5-methylbenzotriazole, 2-(2′-hydroxy-5′-carboxyphenyl)benzotriazole ethyl ester, 2-(2′-hydroxy-3′-methyl-5′-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-5′-methoxyphenyl)benzotriazole, 2-(2′-hydroxy-3′,5′-di-t-butyl phenyl)-5-chlorobenzotriazole, 2-(2′-hydroxy-5′-cyclohexylphenyl)benzotriazole, 2-(2′-hydroxy-4′,5′-dimethylphenyl)-5-carboxybenzotriazole butyl ester, 2-(2′-hydroxy-3′,5′-dichlorophenyl)benzotriazole, 2-(2′-hydroxy-4′,5′-dichlorophenyl)benzotriazole, 2-(2′-hydroxy-3′,5′-dimethylphenyl)-5-ethylsulfonylbenzotriazole, 2-(2′-hydroxy-4′-octoxyphenyl)benzotriazole, 2-(2′-hydroxy-5′-methoxyphenyl)-5-methylbenzotriazole, 2-(2′-hydroxy-5′-methylphenyl)-5-carboxybenzotriazole ester, 2-(2′-acetoxy-5′-methylphenyl)benzotriazole, 2-(2′-hydroxy-5′-t-octylphenyl)benzotriazole, and so forth.

Examples further include multimers and polymers of these benzophenone type compounds and benzotriazole type compounds. These benzophenone type compounds and benzotriazole type compounds can be used alone or as a mixture of two or more kinds to impart sufficient anti-ultraviolet property.

The content of the ultraviolet absorber varies depending on the type of the ultraviolet absorber to be used, thickness of the anti-ultraviolet layer, and so forth, and therefore it cannot be generally defined. However, it is preferably 1 to 20 parts by weight, more preferably 5 to 15 parts by weight, with respect to 100 parts by weight of the binder component. By using the ultraviolet absorber at a content of 1 part by weight or more with respect to 100 parts by weight of the binder component, sufficient anti-ultraviolet property can be imparted, and by using it at a content of 20 parts by weight or less, increase of yellowing due to the ultraviolet absorber can be suppressed, it can be made sufficiently miscible with the aforementioned ionizing radiation curable resin composition, and reduction of the hard coat property of the anti-ultraviolet layer can be prevented. That is, even if the ultraviolet absorber is used at a content exceeding 20 parts by weight, further improvement in the anti-ultraviolet property cannot be obtained, and such a content rather invites increase in yellowing of the anti-ultraviolet layer, and in addition, degradation of physical properties of the coated layer such as surface hardness.

Hereafter, the microparticles will be explained. The microparticles are used in order to reduce yellow tint of the anti-ultraviolet layer already yellowed by the ultraviolet absorber. The type of the microparticles is not particularly limited, and inorganic microparticles such as those of calcium carbonate, magnesium carbonate, barium sulfate, aluminum hydroxide, silica, kaolin, clay, and talc, resin microparticles such as those of acrylic resin, polystyrene resin, polyurethane resin, polyethylene resin, benzoguanamine resin, and epoxy resin, and so forth can be used.

As for both of the inorganic microparticles and the resin microparticles, spherical microparticles having a mean particle diameter of 1 to 20 μm, preferably 2 to 10 μm are used. The reason why use of such particular microparticles can suppress the yellowing of the anti-ultraviolet layer is not necessarily clear, it is considered that use of spherical microparticles enables impartation of higher external haze than microparticles having other shapes (e.g., irregular shapes) with a relatively small content that does not degrade transparency required for a surface protective sheet, and thus they exhibit an effect that the yellow tint is made less conspicuous by diffusion of lights. Moreover, it is also considered that if the mean particle diameter of the microparticles is 1 μm or larger, convex portions formed by the microparticles can be formed in an appropriate shape on the surface of the anti-ultraviolet layer, and an effect of the external haze obtained thereby reduces the yellow tint. Moreover, by using the microparticles having a mean particle diameter of 20 μm or smaller, the external haze can be prevented from becoming unduly large so that the transparency can be maintained, and the microparticles can be prevented from exfoliating from the anti-ultraviolet layer. Moreover, it makes it unnecessary to form an anti-ultraviolet layer having an unduly large thickness for avoiding the exfoliation of the microparticles.

The content of the microparticles in the anti-ultraviolet layer is 0.4 to 3% by weight, preferably 0.7 to 1.5% by weight. If the content of the microparticles is 0.4% by weight or larger, the yellow tint of the anti-ultraviolet layer yellowed by the ultraviolet inhibitor can be reduced. The content is 3% by weight or lower, because even if they are added at a content exceeding such a content, the effect of reducing yellow tint does not change, but it invites only reduction of the transparency.

It is also preferred that the aforementioned anti-ultraviolet layer should contain 0.01 to 1% by weight of organopolysiloxane. Since generation of fine unevenness of convex and concave portions on the surface of the anti-ultraviolet layer can be prevented by adding 0.01% by weight or more of an organopolysiloxane, the yellow tint can be further reduced. Further, the content of the organopolysiloxane is defined to be 1% by weight or less, because even if the organopolysiloxane is added at a content exceeding that level, the effect of reducing the yellow tint does not change, but it invites only reduction of the surface hardness of the anti-ultraviolet layer.

Since the thickness of the anti-ultraviolet layer varies depending on the size of the microparticles, content of the ultraviolet absorber, and so forth, it cannot generally be defined. However, it is preferably a thickness corresponding to 20 to 80%, preferably 40 to 70%, of the mean particle diameter of the microparticles, in view of reduction of the yellow tint. When the thickness is 20% or more of the mean particle diameter, exfoliation of the microparticles from the anti-ultraviolet layer can be prevented, and the anti-ultraviolet property and indispensable minimum surface hardness can be obtained. When the thickness is 80% or less of the mean particle diameter, convex portions formed by the microparticles can have an appropriate shape on the surface of the anti-ultraviolet layer, and the yellow tint can be reduced by an effect of the external haze obtained thereby.

Specifically, the thickness of the anti-ultraviolet layer is preferably about 1 to 15 μm, more preferably about 3 to 10 μm. When the thickness of the anti-ultraviolet layer is 1 μm or larger, exfoliation of the microparticles from the anti-ultraviolet layer can be prevented, and sufficient hard coat property and necessary anti-ultraviolet property can be imparted. When the thickness is 15 μm or smaller, convex portions can be formed with the microparticles on the surface of the anti-ultraviolet layer, generation of curling due to shrinkage during curing can be prevented, and reduction of the hard coat property due to insufficient curing can be prevented.

The anti-ultraviolet layer may contain various additives such as lubricants, other microparticles, fluorescent whitening agents, pigments, dyes, antistatic agents, flame retardants, antimicrobial agents, antifungal agents, antioxidants, plasticizers, leveling agents, flow regulators, antifoaming agents, dispersing agents, and crosslinking agents, so long as the functions of the surface protective sheet of the present invention are not degraded.

The surface protective sheet of the present invention explained above can be obtained by preparing a mixture of the aforementioned ultraviolet absorber, microparticles, and ionizing radiation curable resin composition, as well as other resins, other additives, dilution solvent added as required, and the like, coating the mixture on at least one surface of the aforementioned plastic film by a conventionally known coating method, for example, coating by using a bar coater, dye coater, blade coater, spin coater, roll coater, gravure coater, curtain coater, spraying, screen stencil, and so forth, then drying the coated layer as required, and curing the layer by irradiation with-ionizing radiation to form the anti-ultraviolet layer.

As for the method of irradiating ionizing radiation, ultraviolet rays in a wavelength range of 100 to 400 nm, preferably 200 to 400 nm, emitted from an ultra high pressure mercury lamp, high pressure mercury lamp, low pressure mercury lamp, carbon arc, metal halide lamp, or the like can be irradiated, or electron beams in a wavelength range of 100 nm or shorter emitted from a scanning type or curtain type electron beam accelerator can be irradiated to attain the irradiation.

As explained above, the surface protective sheet of the present invention exhibits superior anti-ultraviolet property, and suffers from little yellow tint, and therefore color fading of pictures, characters and images on surfaces of displays can be prevented with it. In particular, even images or backgrounds in white color or pale color can be protected without changing tint of the color.

### EXAMPLES

Hereafter, the present invention will be explained in more detail on the basis of the examples. The term and symbol, “part” and “%”, are used in weight basis in the examples, unless specifically indicated.

### Example 1

On one surface of a polyethylene terephthalate film having a b* value of 1.0 and a thickness of 188 μm as a transparent plastic film, a coating solution for anti-ultraviolet layer having the following composition was applied, dried, and irradiated with ultraviolet rays by using a high pressure mercury lamp to form an anti-ultraviolet layer having a thickness of 4 μm and thus prepare a surface protective sheet of Example 1.

<Composition of coating solution for anti-ultraviolet layer
of Example 1>

| | | |
|---|---|---|
| Ionizing radiation curable resin composition (solid | 15 | parts |
| content: 100%, DIABEAM UR6530, Mitsubishi | | |
| Rayon Co., Ltd.) | | |
| Ultraviolet absorber (formula weight: 315.8, 2-(2′- | 1.2 | parts |
| hydroxy-3′-t-butyl-5′-methylphenyl)-5-chlorobenzotriazole, | | |
| KEMISORB 72, Chemiprokasei Kaisha) | | |
| Ultraviolet absorber (formula weight: 323.4, 2-(2′- | 0.9 | part |
| hydroxy-5′-t-octylphenyl)benzotriazole, KEMISORB 79, | | |
| Chemiprokasei Kaisha) | | |
| Spherical microparticles (silica, mean particle diameter: | 0.15 | part |
| 6 μm, Highpresica TS-N3N, Ube-Nitto Kasei Co., Ltd.) | | |
| Organopolysiloxane (solid content: 100%, BYK307, BYK- | 0.1 | part |
| Chemie Japan KK) | | |
| Photopolymerization initiator (DAROCUR 1700, Ciba | 1.0 | part |
| Speciality Chemicals Inc.) | | |
| Photopolymerization initiator (Irgacure 651, Ciba | 0.5 | part |
| Speciality Chemicals Inc.) | | |
| Ethyl acetate | 25 | parts |
| Butyl acetate | 35 | parts |
| Cyclohexanone | 10 | parts |

### Example 2

A surface protective sheet of Example 2 was prepared in the same manner as that of Example 1 except that the coating solution for anti-ultraviolet layer of Example 1 was changed to a coating solution for anti-ultraviolet layer having the following composition.

<Composition of coating solution for anti-ultraviolet layer
of Example 2>

| | | |
|---|---|---|
| Ionizing radiation curable resin composition (solid | 15 | parts |
| content: 100%, DIABEAM UR6530, Mitsubishi | | |
| Rayon Co., Ltd.) | | |
| Ultraviolet absorber (formula weight: 315.8, 2-(2′- | 1.2 | parts |
| hydroxy-3′-t-butyl-5′-methylphenyl)-5-chlorobenzotriazole, | | |
| KEMISORB 72, Chemiprokasei Kaisha) | | |
| Ultraviolet absorber (formula weight: 323.4, 2-(2′- | 0.9 | part |
| hydroxy-5′-t-octylphenyl)benzotriazole, KEMISORB 79, | | |
| Chemiprokasei Kaisha) | | |
| Spherical microparticles (crosslinked acrylic resin, mean | 0.25 | part |
| particle diameter: 5 μm, MB20X-5, Sekisui Plastics Co., | | |
| Ltd.) | | |
| Organopolysiloxane (solid content: 100%, BYK307, BYK- | 0.1 | part |
| Chemie Japan KK) | | |
| Photopolymerization initiator (DAROCUR 1700, Ciba | 1.0 | part |
| Speciality Chemicals Inc.) | | |
| Photopolymerization initiator (Irgacure 651, Ciba | 0.5 | part |
| Speciality Chemicals Inc.) | | |
| Methyl ethyl ketone | 30 | parts |
| Ethyl acetate | 35 | parts |
| Cyclohexanone | 5 | parts |

### Example 3

A surface protective sheet of Example 3 was prepared in the same manner as that of Example 1 except that, in the coating solution for anti-ultraviolet layer of Example 1, the organopolysiloxane was not added, and the amount of the ionizing radiation curable resin composition was changed to 15.1 parts.

### Example 4

A surface protective sheet of Example 4 was prepared in the same manner as that of Example 1 except that, in the coating solution for anti-ultraviolet layer of Example 1, the spherical microparticles were changed to spherical microparticles having a mean particle diameter of 4.5 μm (silica, SYLOSPHERE C-1504, Fuji Silysia Chemical Ltd.).

### Comparative Example 1

A surface protective sheet of Comparative Example 1 was prepared in the same manner as that of Example 3 except that, in the coating solution for anti-ultraviolet layer of Example 3, the spherical microparticles were not added.

### Comparative Example 2

A surface protective sheet of Comparative Example 2 was prepared in the same manner as that of Example 3 except that, in the coating solution for anti-ultraviolet layer of Example 3, the spherical microparticles were changed to microparticles of irregular shape having a mean particle diameter of 5.7 μm (silica, Sylysia 256, Fuji Silysia Chemical Ltd.).

### Comparative Example 3

A surface protective sheet of Comparative Example 3 was prepared in the same manner as that of Example 3 except that, in the coating solution for anti-ultraviolet layer of Example 3, the spherical microparticles were changed to spherical microparticles having a mean particle diameter of 0.5 μm (silica, ADMAFINE SO-E2, ADMATECHS CO., LTD.).

The surface protective sheets obtained in Examples 1 to 4 and Comparative Examples 1 to 3 were evaluated for yellow tint, transparency, and anti-ultraviolet property. The evaluation results are shown in Table 1.
(1) Evaluation of Yellow Tint

b* values of the surface protective sheets obtained in Examples 1 to 4 and Comparative Examples 1 to 3 were measured according to JIS K5600-4-4:1999, JIS K5600-4-5:1999, and JIS K5600-4-6:1999 by using a color difference meter (ZE2000, Nihon Denshoku Industries Co., Ltd.).
(2) Evaluation of Transparency

Hazes of the surface protective sheets obtained in Examples 1 to 4 and Comparative Examples 1 to 3 were measured according to JIS K7136:2000 by using a haze meter (NDH2000, Nihon Denshoku Industries Co., Ltd.). For the measurement, the lights were entered from the surfaces having the anti-ultraviolet layers.
(3) Evaluation of Anti-Ultraviolet Property
(a) Light Transmission for Wavelength of 380 nm

Light transmissions for a wavelength of 380 nm of the surface protective sheets obtained in Examples 1 to 4 and Comparative Examples 1 to 3 were measured by using a spectrophotometer (UV-3101PC, Shimadzu Corp.).
(b) Light Resistance of Images

A display board comprising a plastic sheet on one of which surface images were printed by using ultraviolet curing ink (FDOR, Joto Ink Mfg. Co., Ltd.) was prepared, and the printed surface of the display board and the surface of each of the surface protective sheets obtained in Examples 1 to 4 and Comparative Examples 1 to 3 not having the anti-ultraviolet layer were adhered with an adhesive. Then, by using an accelerated light resistance test machine (ultraviolet fade meter FAL-5, Suga Test Instruments Co., Ltd.), which had light irradiation acceleration ability to attain ultraviolet irradiation equivalent to ultraviolet irradiation over 1 year in the outdoors by irradiation of 200 hours, ultraviolet irradiation was performed for 300 hours on the surface protective sheet side, and then color change and fading of the printed images on the display board were evaluated by visual inspection. A result of substantially no color change and fading was indicated with “O”

TABLE 1

| | Yellow | | Anti-ultraviolet | |
|---|---|---|---|---|
| | tint | | property | |
| | b* | Transparency | Light (380 nm) | Light resistance |
| | value | Haze | transmission | of Image |
| Example 1 | 1.60 | 8.8% | 15% | ◯ |
| Example 2 | 1.63 | 8.4% | 15% | ◯ |
| Example 3 | 1.65 | 8.6% | 15% | ◯ |
| Example 4 | 1.66 | 6.1% | 15% | ◯ |
| Comparative | 1.77 | 1.5% | 15% | ◯ |
| Example 1 | | | | |
| Comparative | 1.68 | 8.0% | 15% | ◯ |
| Example 2 | | | | |
| Comparative | 1.69 | 5.3% | 15% | ◯ |
| Example 3 | | | | |

As clearly seen from the results shown in Table 1, because the anti-ultraviolet layers of the surface protective sheets of Examples 1 to 4 were formed from an ultraviolet absorber, an ionizing radiation curable resin composition, and microparticles having a mean particle diameter of 1 to 20 μm, and contained 0.4 to 3% by weight of the microparticles, they could be surface protective sheets with little yellow tint compared with the surface protective sheet of Comparative Example 1, which did not contain microparticles.

In particular, because the thicknesses of the anti-ultraviolet layers of the surface protective sheets of Examples 1 to 3 were 67%, 80%, and 67% of the mean particle diameters of spherical microparticles, respectively, the yellow tint could further be reduced.

Further, because the surface protective sheets of Examples 1 and 2 contained 0.55% by weight of the organopolysiloxane in the anti-ultraviolet layers, they could best reduce the yellow tint.

On the other hand, the surface protective sheet of Comparative Example 2 could not reduce the yellow tint unlike the surface protective sheets of the examples containing spherical microparticles, because the microparticles of the surface protective sheet of Comparative Example 2 had irregular shapes, although the mean particle diameter of the microparticles in the anti-ultraviolet layer and the thickness of the anti-ultraviolet layer were substantially the same as those used in Example 3.

Moreover, as for the surface protective sheet of Comparative Example 3, since the thickness of the anti-ultraviolet layer was 4 μm, and the mean particle diameter of the spherical microparticles was less than 1 μm, the microparticles could not form convex portions on the surface of the anti-ultraviolet layer, and thus the sheet could not reduced the yellow tint unlike the surface protective sheets of the examples.

1. A surface protective sheet having an anti-ultraviolet layer on at least one surface of a plastic film, wherein the anti-ultraviolet layer comprises at least an ionizing radiation curable resin composition, an ultraviolet absorber and spherical microparticles having a mean particle diameter of 1 to 20 μm, and the microparticles are contained in an amount of 0.4 to 3% by weight in the anti-ultraviolet layer.

2. The surface protective sheet according to claim 1, wherein the anti-ultraviolet layer contains 0.01 to 1% by weight of an organopolysiloxane.

3. The surface protective sheet according to claim 1, wherein the thickness of the anti-ultraviolet layer is 20 to 80% of the mean particle diameter of the microparticles.

4. The surface protective sheet according to claim 1, wherein the ultraviolet absorber is an ultraviolet absorber having a formula weight of 200 to 400.

5. The surface protective sheet according to claim 2, wherein the thickness of the anti-ultraviolet layer is 20 to 80% of the mean particle diameter of the microparticles.

6. The surface protective sheet according to claim 2, wherein the ultraviolet absorber is an ultraviolet absorber having a formula weight of 200 to 400.

7. The surface protective sheet according to claim 3, wherein the ultraviolet absorber is an ultraviolet absorber having a formula weight of 200 to 400.
